(19) United States
(12) Patent Application Publication
(10) Pub. No.: US 2019/0034781 A1
(43) Pub. Date: Jan. 31, 2019

(54) NETWORK COEFFICIENT COMPRESSION DEVICE, NETWORK COEFFICIENT COMPRESSION METHOD, AND COMPUTER PROGRAM PRODUCT

(71) Applicant: Kabushiki Kaisha Toshiba, Minato-ku (JP)

(72) Inventors: Wataru ASANO, Yokohama (JP); Takuya MATSUO, Kawasaki (JP)

(73) Assignee: Kabushiki Kaisha Toshiba, Minato-ku (JP)

(21) Appl. No.: 15/887,321

(22) Filed: Feb. 2, 2018

(30) Foreign Application Priority Data
Jul. 31, 2017 (JP) 2017-147769

(51) Int. Cl. G06N 3/04; G06N 5/04; G06F 15/18; G06N 99/00

(52) U.S. Cl. CPC G06N 3/04; G06N 5/04; G06N 3/084; G06N 99/005; G06F 15/18

(57) ABSTRACT

According to an embodiment, a network coefficient compression method includes: outputting, with respect to input data input into an input layer of a learned neural network, an output value in a hidden layer or an output layer of the neural network; and generating a compressed network coefficient by learning a network coefficient of the neural network, with the input data and the output value as training data, while performing lossy compression of the network coefficient.

### CROSS-REFERENCE TO RELATED APPLICATIONS

This application is based upon and claims the benefit of priority from Japanese Patent Application No. 2017-147769, filed on Jul. 31, 2017; the entire contents of which are incorporated herein by reference.

### FIELD

Embodiments described herein relate generally to a network coefficient compression device, a network coefficient compression method, and a computer program product.

### BACKGROUND

Recently, a multi-layer neural network (deep neural network) is used widely, and the number of network coefficients (such as weight coefficient and bias) is increased significantly. In a case where inference is made by utilization of such a neural network, a data size of network coefficients becomes enormous. As a result, a high-capacity memory becomes necessary as a memory to store the network coefficients, and a memory bandwidth between a calculation unit that calculates an output value in each layer of a neural network and the memory becomes tight. Thus, it is demanded to reduce an amount of data of the network coefficients.

For example, a technology of reducing an amount of data by performing quantization of a weight coefficient, pruning of a weight coefficient, and compression using a Huffman code is proposed. In this technology, quantization and pruning processing is performed during learning, whereby an influence of compression on performance of a task such as recognition is controlled.

### BRIEF DESCRIPTION OF THE DRAWINGS

FIG. 1 is a block diagram of a network coefficient compression device according to a first embodiment;

FIG. 2 is a view illustrating a configuration example of a neural network;

FIG. 3 is a flowchart of network coefficient compression processing in the first embodiment;

FIG. 4 is a block diagram of a learning unit of a second embodiment;

FIG. 5 is a flowchart of network coefficient compression processing in the second embodiment;

FIG. 6 is a block diagram of a recognition device of a third embodiment; and

FIG. 7 is a hardware configuration view of a network coefficient compression device according to each of the first to third embodiments.

### DETAILED DESCRIPTION

According to an embodiment, a network coefficient compression method includes: outputting, with respect to input data input into an input layer of a learned neural network, an output value in a hidden layer or an output layer of the neural network; and generating a compressed network coefficient by learning a network coefficient of the neural network, with the input data and the output value as training data, while performing lossy compression of the network coefficient.

In the following, preferred embodiments of a network coefficient compression device according to this invention will be described in detail with reference to the attached drawings.

### First Embodiment

A network coefficient compression device according to the first embodiment compresses a network coefficient (such as weight coefficient or bias) during learning by using, as training data, a result of inference of a learned neural network. Accordingly, it becomes possible to realize a high compression rate while controlling deterioration in performance of a task such as recognition.

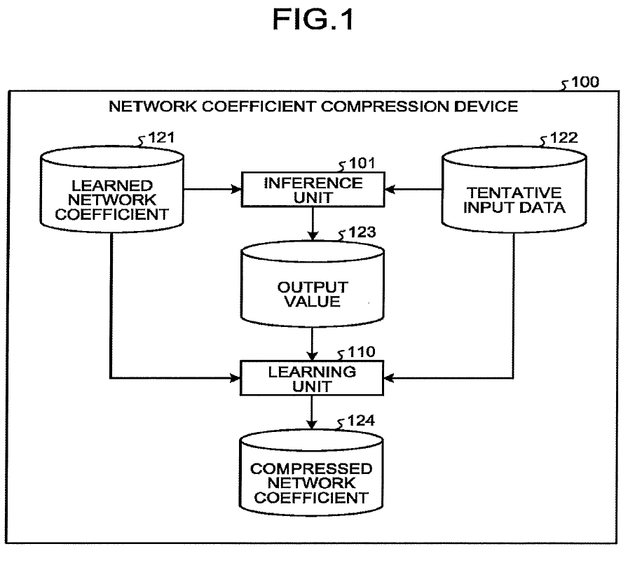

FIG. 1 is a block diagram illustrating an example of a configuration of a network coefficient compression device 100 according to the first embodiment. As illustrated in FIG. 1, the network coefficient compression device 100 includes an inference unit 101, and a learning unit 110.

A learned network coefficient 121, tentative input data 122, an output value 123, and a compressed network coefficient 124 are data input/output in each kind of processing by the network coefficient compression device 100. These pieces of data are stored in a storage unit inside or outside the network coefficient compression device 100, for example. This storage unit can include any kind of generally-used storage medium such as a hard disk drive (HDD), an optical disk, a memory card, or a random access memory (RAM). The storage unit may be physically-different storage media, or may be realized as different storage regions of the physically-same storage medium. Moreover, the storage unit may be realized by a plurality of physically-different storage media.

The above units (inference unit and learning unit) are realized, for example, by one or a plurality of processors. For example, the above units may be realized by execution of a program by a processor such as a central processing unit (CPU), that is, by software. The above units may be realized by a processor such as a special integrated circuit (IC), that is, by hardware. The above units may be realized by utilization of software and hardware in combination. In a case where a plurality of processors is used, each processor may realize one of the units or two or more of the units.

The inference unit 101 makes inference (estimation) using a learned neural network. For example, the inference unit 101 inputs tentative input data into an input layer of a leaned neural network, and outputs an output value, for the input input data, of a hidden layer or an output layer of the neural network. The output output value corresponds to an output value inference of which is performed according to the learned neural network.

The learning unit 110 performs, with tentative input data and an output value corresponding to the tentative input data being training data, lossy compression and learning of a network coefficient of a learned neural network, and generates and outputs a compressed network coefficient. A compressed network coefficient is, for example, at least one of a weight coefficient and a bias. The lossy compression is, for example, quantization processing. In a case where lossy compression such as quantization is performed, there is a possibility that performance of a task such as recognition is deteriorated. When learning of a network coefficient is performed along with lossy compression in such a manner of the present embodiment, it becomes possible to control deterioration in performance of a task.

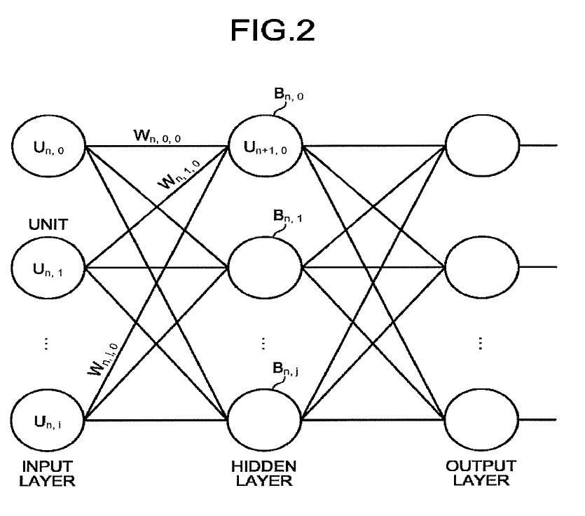

Here, a configuration example of a neural network will be described. FIG. 2 is a view illustrating a configuration example of a neural network.

A neural network is a mathematical model aiming to express a several characteristics seen in a brain function by computational simulation. The neural network generally includes an input layer including an input unit that receives information from the outside, an output layer including an output unit that outputs information to the outside, and one or a plurality of hidden layers intermediate layer) including a unit placed between the input layer and the output layer.

In FIG. 2, each circle indicates a unit. After receiving information from a plurality of units in a different layer and performing some kind of processing, each unit outputs the information. Generally, an output value U_{n+1,j} of a jth unit in an (n+1)th layer is expressed by the following expression (1). W_{n,i,j}, is a weight coefficient, B_{n,j} is a bias, and f( ) is an activating function. U_{n,i} indicates an output value of an ith unit in an nth layer.

$${U}_{n + 1 , j} = f ( {\sum }_{i} {W}_{n , i , j} {U}_{n , i} + {B}_{n , j} ) \qquad ( 1 )$$

In a learning phase of a neural network, a weight coefficient and a bias are updated in such a manner that an appropriate output value is acquired. In an inference phase, an output value is calculated by utilisation of the weight coefficient and the bias acquired by the learning phase.

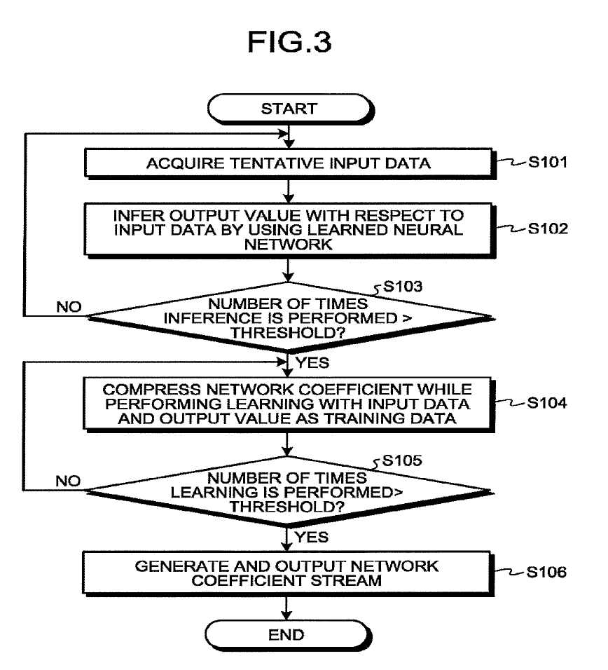

Next, network coefficient compression processing by the network coefficient compression device 100 according to the first embodiment configured in such a manner will be described with reference to FIG. 3. FIG. 3 is a flowchart illustrating an example of the network coefficient compression processing in the first embodiment.

The inference unit 101 receives an input of tentative input data (Step S101). The tentative input data may be an artificial signal such as a random signal, or image data, audio data, text data, and the like that are assumed to be input into an object network may be used. When possible, learning data used in learning of an original network may be used as input data.

The inference unit 101 infers a neural network with respect to tentative input data by using a learned network coefficient (such as weight coefficient or bias), and acquires one or more output values of each unit in a hidden layer and an output layer, the values corresponding to the input data (Step S102). An output value is, for example, U_{n+1, j} in the above expression (1). A likelihood or the like acquired by softmax processing of an output layer may be an output value.

The inference unit 101 determines whether the number of times inference processing is performed (number of times inference is performed) exceeds a threshold (threshold of number of times inference is performed) (Step S103). In a case where the number of times inference is performed does not exceed the threshold (Step S103: No), the processing is brought back to Step S101 and repeated. By repetition of the inference processing, the intended number of pairs of input data and an output value can be acquired.

Note that the processing to acquire a pair of input data and an output value (Step S101 to Step S103) only needs to be ended before execution of processing in and after compression processing (Step S104 to Step S106). That is, Step S101 to Step S103, and Step S104 to Step S106 are not necessarily executed continuously.

In a case where the number of times inference is performed exceeds the threshold (Step S103: Yes), the learning unit 110 performs compression and learning of a learned network coefficient with an acquired pair of input data and an output value being training data (Step S104). The learning unit 110 can be realized by an arbitrary method as long as compression is performed during learning in the method. Accordingly, since compression can be performed during learning, an influence of the compression on performance of a task such as recognition can be controlled.

The learning unit 110 determines whether the number of times learning processing is performed (number of times learning is performed) exceeds a threshold (threshold of number of times learning is performed) (Step S105). In a case where the number of times learning is performed does not exceed the threshold (Step S105: No), the processing is brought back to Step S104 and repeated. In a case where the number of times learning is performed exceeds the threshold (Step S105: Yes), the learning unit 110 generates and outputs a bit stream indicating a compressed network coefficient (network coefficient stream) (Step S106).

In such a manner, in the network coefficient compression device according to the first embodiment, tentative input data, and an output value in a learned neural network with respect to this input data are used as training data. Thus, compression and learning of a network coefficient can be performed without a learning data set used in learning of an original network.

### Second Embodiment

In the second embodiment, an example with more-specific compression and update of a network coefficient will be described. A whole configuration of a network coefficient compression device according to the second embodiment is similar to that of the first embodiment. In the second embodiment, a configuration of a learning unit 110-2 is different from that of the learning unit 110 of the first embodiment in the following, a configuration and a function of the learning unit 110-2 will be mainly described.

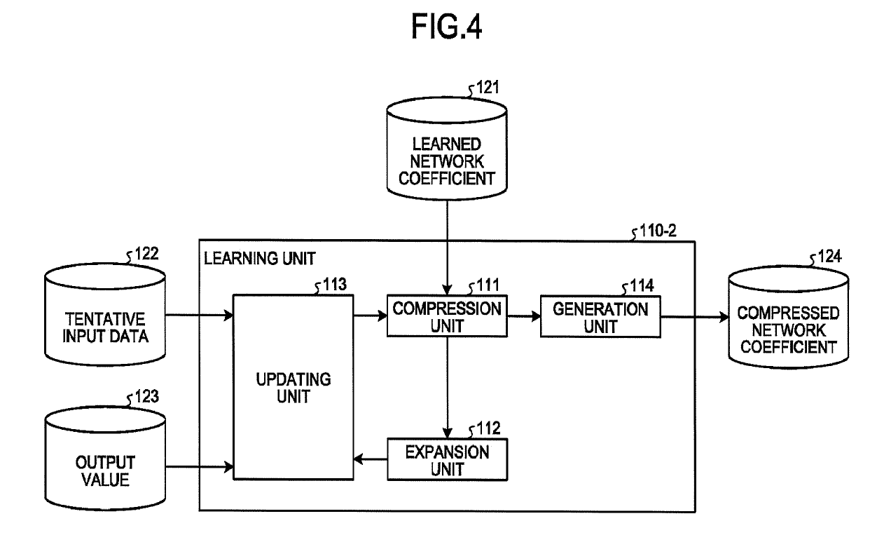

FIG. 4 is a block diagram illustrating an example of a detailed configuration of the learning unit 110-2. The learning unit 110-2 includes a compression unit 111, an expansion unit 112, an updating unit 113, and a generation unit 114.

The compression unit 111 performs lossy compression of a network coefficient. The lossy compression is, for example, linear quantization, and non-linear quantization. The compression unit 111 quantizes a network coefficient according to quantization parameters such as a quantization bit rate, a quantization step width, a quantization offset, and a representative value.

The expansion unit 112 expands a compressed network coefficient, and performs an output thereof to the updating unit 113. The expansion unit 112 expands the compressed network coefficient by expansion processing corresponding to compression processing by the compression unit 111. For example, in a case where the compression unit 111 performs quantization, the expansion unit 112 performs inverse quantization corresponding to this quantization.

Note that a network coefficient before the compression is, for example, a floating point (16 bit, 32 bit, or 64 bit) or a fixed point (8 bit). The number of bits of a network coefficient becomes smaller by compression (quantization). The expansion unit 112 executes expansion processing in such a manner that the number of bits becomes that of a network coefficient before the compression.

The updating unit 113 updates a network coefficient by using a technique of machine learning with tentative input data used in an inference unit 101, and an output value with respect to the input data being training data. As the technique of machine learning, an arbitrary technique such as backpropagation can be applied.

Although a label is a trainer in ordinary supervised learning, an output value with respect to the tentative input data used in the inference unit 101 is a trainer in the present embodiment. Thus, even in a case where a data set used in network learning before the compression cannot be used, an own supervised data set can be prepared. Also, since output values of a plurality of units are used instead of a label, an error from a network before the compression can be calculated accurately, and a coefficient can be updated to be closer to an output of the network before the compression.

The generation unit 114 generates a network coefficient stream from a compressed network coefficient, and performs an output thereof. In a case of compression by quantization, the generation unit 114 encodes a quantization bit rate, a quantization step width, a quantization offset, a quantization table, and the like as header information, when necessary. Also, the generation unit 114 may perform entropy coding such as Huffman coding and arithmetic coding with respect to a quantization value.

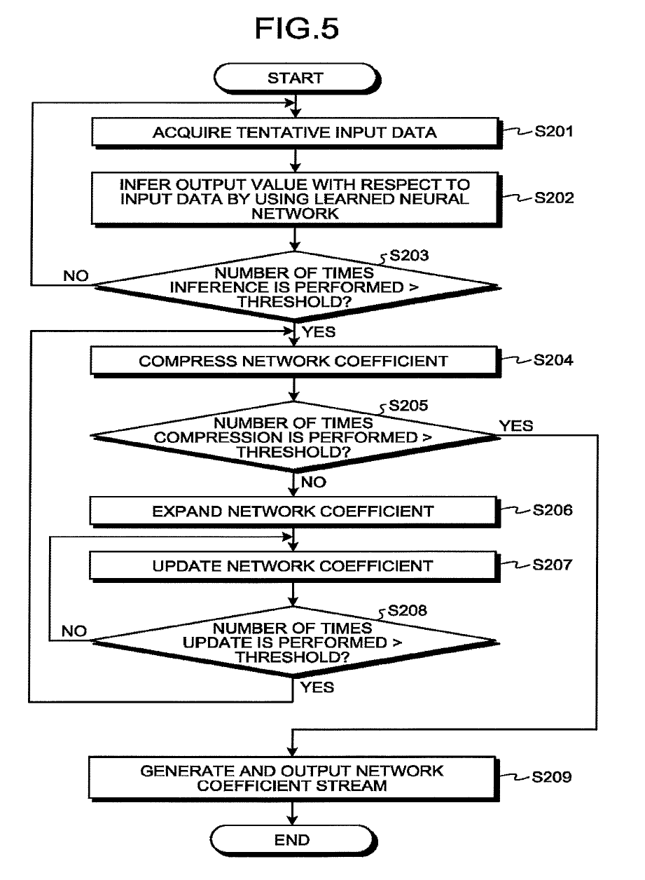

Next, network coefficient compression processing by a network coefficient compression device according to the second embodiment configured in such a manner will be described with reference to FIG. 5. FIG. 5 is a flowchart illustrating an example of the network coefficient compression processing in the second embodiment.

Since Step S201 to Step S203 are processing similar to Step S101 to Step S103 in the network coefficient compression device 100 according to the first embodiment, a description thereof is omitted.

The compression unit 111 performs lossy compression of a learned network coefficient (Step S204). The compression unit 111 may use a common quantization parameter for all network coefficients or may switch a quantization parameter in each predetermined unit. The predetermined unit is, for example, one layer, a plurality of layers, one unit, or a plurality of units. The compression processing may be performed in all layers or may be performed only in a part of layers. Also, compression with respect to each layer is not necessarily performed at all times, and a different layer may be compressed at each time of repetition. For example, the compression unit 111 may compress a certain layer in the middle of repetition, or may alternately switch layers to be compressed at each time of repetition.

The compression unit 111 determines whether the number of times compression is performed exceeds a threshold (Step S205). In a case where the number of times compression is performed does not exceed the threshold (Step S205: No), the expansion unit 112 expands a compressed network coefficient into a signal with the original number of bits (Step S206).

Next, the updating unit 113 updates the expanded network coefficient by using a technique of machine learning such as backpropagation (Step S207). The updating unit 113 determines whether the number of times update processing is performed (number of times update is performed) exceeds a threshold (threshold of number of times update is performed) (Step S208).

In a case where the number of times update is performed does not exceed the threshold (Step S208: No), the updating unit 113 goes back to Step S207 and repeats the processing. In a case where the number of times update is performed exceeds the threshold (Step S208: Yes), the processing is brought back to Step S204 and the compression processing is further repeated.

The number of times update is performed is determined in such a manner that the compression processing is executed in units of one round of learning data (epoch), for example. A method of determining the number of times update is performed is not limited to this and an arbitrary method can be applied. For example, it may be determined that the compression processing is executed at a half of an epoch. Also, repetition may not be performed, and compression may be performed each time a coefficient is updated (in each batch). In such a manner, the learning unit 110-2 (compression unit 111) may execute lossy compression in a predetermined unit including an epoch and a batch.

In a case where the number of times compression is performed exceeds the threshold (Step S205: Yes), the generation unit 114 generates and outputs a stream of a compressed network coefficient (network coefficient stream) (Step S209).

According to the learning unit 110-2 of the second embodiment, by performing an update of a compressed network coefficient with an output of a neural network before compression being training data, it is possible to acquire, from learning, a compressed network coefficient with which an output close to that of the neural network before the compression is acquired. Thus, it becomes possible to improve a compression rate while controlling an influence on performance of a task such as recognition.

### MODIFICATION EXAMPLE

A compression method by a learning unit 110-2 (compression unit 111) is not limited to the above. For example, the compression unit 111 may divide learned network coefficients into a plurality of groups, and may perform compression in such a manner that network coefficients that belong to the same group become a common value. In this case, an updating unit 113 may perform an update by using the same update range with respect to network coefficients that belong to the same group. With such a compression method, learning including compression of a network coefficient with a pair of tentative input data, and an output value with respect to this input data being training data can be also performed.

### Third Embodiment

In the third embodiment, a device that executes a task using a neural network compressed by a network coefficient compression device of each of the above embodiments will be described. In the following, an example of a recognition device 500 that includes the network coefficient compression device 100 of the first embodiment, and that executes recognition processing using a neural network will be described. The network coefficient compression device of the second embodiment may be included instead of the network coefficient compression device 100 of the first embodiment. Also, an applicable task is not limited to the recognition processing. Application to an arbitrary task, which uses a neural network, such as regression analysis is possible.

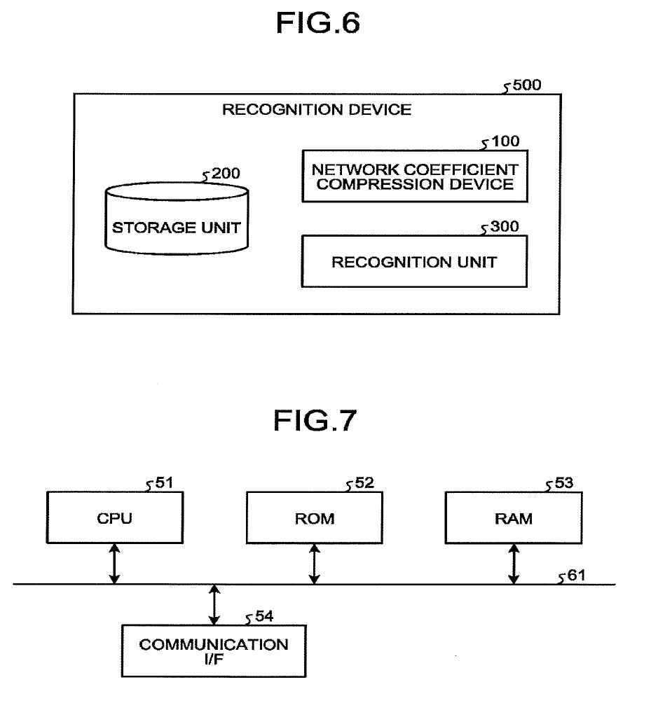

FIG. 6 is a block diagram illustrating an example of configuration of the recognition device 500 of the third embodiment. The recognition device 500 includes the network coefficient compression device 100, a storage unit 200, and a recognition unit 300.

The storage unit 200 stores various kinds of information such as a learned network coefficient before compression, and a network coefficient compressed by the network coefficient compression device 100. The storage unit 200 corresponds to a storage unit that stores the learned network coefficient 121, the tentative input data 122, the output value 123, and the compressed network coefficient 124 in FIG. 1, for example.

The recognition unit 300 executes recognition processing by using a neural network expressed by a compressed network coefficient. For example, in a case where an object in an image is recognized, a neural network learned with a plurality of classes classifying an object (such as vehicle, person, and animal) being a recognition object is used. For example, the recognition unit 300 inputs an image feature amount (feature vector) extracted from an image into a neural network, and recognizes to which class an object belongs on the basis of a likelihood or the like output from an output layer. The recognition processing is not limited to image recognition, and can be applied to different arbitrary pattern recognition such as speech recognition.

The recognition unit 300 outputs a result of the recognition to a display device such as a display, an external device connected by a network or the like, a printer (image forming device), and the like.

In such a manner, in the recognition device according to the third embodiment, it becomes possible to execute a task using a neural network in which a network coefficient is compressed in such a manner as to control deterioration in performance.

As described above, according to the first to third embodiments, it becomes possible to realize a high compression rate of a network coefficient of a neural network while controlling deterioration in performance of a task such as recognition.

Next, a hardware configuration of a device according to each of the first to third embodiments (network coefficient compression device or recognition device) will be described with reference to FIG. 7. FIG. 7 is a view for describing a hardware configuration example of a device according to each of the first to third embodiments.

The device according to each of the first to third embodiments includes a control device such as a central processing unit (CPU) 51, a storage device such as a read only memory (ROM) 52 or a random access memory (RAM) 53, a communication I/F 54 that is connected to a network and that performs communication, and a bus 61 that connects the units.

A program executed in the device according to each of the first to third embodiments is previously installed in the ROM 52 or the like and provided.

A program executed in the device according to each of the first to third embodiments may be recorded, in a file of an installable format or an executable format, into a computer-readable recording medium such as a compact disk read only memory (CD-ROM), a flexible disk (FD), a compact disk recordable (CD-R), or a digital versatile disk (DVD), and provided as a computer program product.

Moreover, a program executed in the device according to each of the first to third embodiments may be stored on a computer connected to a network such as the Internet and may be provided by downloading via the network. Also, a program executed in the device according to each of the first to third embodiments may be provided or distributed via a network such as the Internet.

A program executed in the device according to each of the first to third embodiments may cause a computer to function as each unit of the devices described above. In this computer, the CPU 51 can read the program from a computer-readable storage medium onto a primary storage device and perform execution thereof.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A network coefficient compression method comprising:
outputting, with respect to input data input into an input layer of a learned neural network, an output value in a hidden layer or an output layer of the neural network; and
generating a compressed network coefficient by learning a network coefficient of the neural network, with the input data and the output value as training data, while performing lossy compression of the network coefficient.

2. A network coefficient compression device comprising:
an inference unit configured to output, with respect to input data input into an input layer of a learned neural network, an output value in a hidden layer or an output layer of the neural network; and
a learning unit configured to generate a compressed network coefficient by learning a network coefficient of the neural network, with the input data and the output value as training data, while performing lossy compression of the network coefficient.

3. The device according to claim 2, wherein the learning unit includes:
a compression unit configured to execute the lossy compression;
an expansion unit configured to expand the compressed network coefficient; and
an updating unit configured to update the expanded network coefficient by using the training data.

4. The device according to claim 2, wherein the network coefficient is at least one of a weight coefficient and a bias.

5. The device according to claim 2, wherein the lossy compression is quantization processing.

6. The device according to claim 2, wherein the learning unit is configured to execute the lossy compression in a predetermined unit that includes an epoch and a batch.

7. The device according to claim 2, wherein the output value is a likelihood in the output layer.

8. The device according to claim 2, wherein the input data is a random signal.

9. A computer program product comprising a computer-readable medium including programmed instructions, the instructions causing a computer to execute:
outputting, with respect to input data input into an input layer of a learned neural network, an output value in a hidden layer or an output layer of the neural network; and
generating a compressed network coefficient by learning a network coefficient of the neural network, with the input data and the output value as training data, while performing lossy compression of the network coefficient.
